(19) United States
(12) Patent Application Publication
(10) Pub. No.: US 2004/0106739 A1
(43) Pub. Date: Jun. 3, 2004

(54) Blends of substantially random interpolymers with enhanced thermal performance

(76) Inventors: Yunwa Wilson Cheung, Lake Jackson, TX (US); Samuel Ethiopia, Lake Jackson, TX (US); Martin James Guest, Rheinmunster (DE); Pak-Wing S. Chum, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/471,067

(22) PCT Filed: Feb. 19, 2002
(86) PCT No.: PCT/US02/04731

(51) Int. Cl. C08L 23/00; C08L 25/02

(52) U.S. Cl. 525/240; 525/241

(57) ABSTRACT

The present invention pertains to immiscible blends of two or more α-olefin/vinyl aromatic monomer interpolymers, the blend having at least one interpolymer component which comprises 2 to 7 mole percent vinyl aromatic monomer content, and uses for such blends. The blend components are selected to provide superior processability and/or performance, such as upper use temperature, in the blend compositions and in their end use applications.

The present invention pertains to immiscible blends of two or more α-olefin/vinyl aromatic monomer interpolymers, the blend having at least one interpolymer component which comprises 2 to 7 mole percent vinyl aromatic monomer content, and uses for such blends. The blend components are selected to provide superior processability and/or performance, such as upper use temperature, in the blend compositions and in their end use applications.

The generic class of materials covered by substantially random α-olefin/vinyl aromatic monomer interpolymers, and especially ethylene/styrene interpolymers (ESI), are known in the art. They offer a range of material structures and properties which makes them useful for varied applications, such as compatibilizers for blends of polyethylene and polystyrene as described in U.S. Pat. No. 5,460,818. Although of utility in their own right. Industry is constantly seeking to improve the applicability of these interpolymers. Such enhancements may be accomplished via additives or the like, but it is desirable to develop technologies such as blend systems to provide improvements in processability and/or performance without the addition of additives.

Blends comprising two or more substantially random interpolymers are generally known in the art. For example, WO 98/10018 (The Dow Chemical Company) describes blends of interpolymers in which individual interpolymer blend components have differences (>0.5 mol percent) in copolymer vinyl aromatic comonomer content, and/or molecular weight. These blends can exhibit miscible behavior as indicated by their having a single glass transition temp, (Tg) which falls between the Tg's of the ESI blend components, or the blends can exhibit immiscible behavior as indicated by multiple Tg's. Patent EP0869146 A1 (Mitsui Chemicals) describes blends of copolymers of ethylene with an aromatic vinyl compound and/or an α-olefin for which the copolymer blend components each have crystallinity of at least 10 percent and wherein the ratio of degree of crystallinity of the blend components is less than 1. Examples are given for blends of ethylene/styrene copolymers having 0.5, 2.0, 2.7 and 2.9 mol percent styrene comonomer. Patent JP 2000-129043A (Denki Kagaku K. K.) describes blends containing two or more α-olefin/vinyl aromatic monomer copolymers, said copolymers being considered to be of different types with one copolymer having, for example, isotactic diad sequences. Examples are given for blends of ethylene/styrene copolymers wherein the component copolymers have greater than 10 mole percent styrene comonomer content.

Journal references (J. Polym. Sci. Part B: Polym. Phys., volume 38, pages 2976-2987 (2000), authors Y. W. Cheung, M. J. Guest; Procedings of the 58^{th} SPE ANTEC, pages 1828-1832 (2000) authors H. Y. Chen, Y. Cheung, P. S. Chum, A. Hiltner, E. Baer) describe miscibility considerations between ethylene/styrene copolymers which differ in comonomer composition. It was shown that the critical comonomer difference in the styrene content between two copolymers is 10 wt. percent, above which phase separation was found, indicative of an immiscible blend system.

There is a need to provide blends of α-olefin/vinyl aromatic monomer interpolymers with superior performance characteristics, which will further expand the utility of this interesting class of materials. This invention utilizes specific interpolymer blend components having from 2 to 7 mole percent vinyl aromatic monomer. These interpolymers have been found in independent studies of structure/property relationships to have a desirable balance of mechanical properties such as intrinsic tear properties, compatibility and processability. As such they are identified as preferred interpolymer blend components.

The present invention pertains to an immiscible blend of two or more substantially random interpolymers comprising 5 to 95 weight percent of at least one substantially random interpolymer having an overall crystallinity (as measured by differential scanning calorimetry) of at least 20 wt percent, said interpolymer comprising:

a) from 2 to 7 mole percent of one or more vinyl aromatic monomers and

b) the balance comprising ethylene; or a combination of ethylene and at least one or more C₃ to C₂₀ α-olefin monomers, and optionally one or more additional olefin monomers.

In a preferred embodiment, the above-identified interpolymer blend component is utilized in combination with:

A). 5 to 95 weight percent of one or more substantially random interpolymers having an overall crystallinity (as measured by differential scanning calorimetry) of less than 15 wt. %, comprising:

a) greater than 10 mole percent of one or more vinyl aromatic monomers

b) the balance comprising ethylene; or a combination of ethylene and at least one or more C₃ to C₂₀ α-olefin monomers.

c) optionally one or more additional olefin monomers and/or

B) 5 to 95 weight percent of one or more substantially random interpolymers having an overall crystallinity (as measured by differential scanning calorimetry) of greater than 40 wt. %, comprising:

a) less than 3 mole percent of one or more vinyl aromatic monomers

b) the balance comprising ethylene; or a combination of ethylene and at least one or more C₃ to C₂₀ α-olefin monomers.

c) optionally one or more additional olefin monomers

The blends find utility in a wide range of fabricated articles such as calendered sheet, blown or cast films, compression or injection-molded articles, rotomolded or thermoformed parts. The blends can be used in the manufacture of fibers, foams and latexes, and be utilized in adhesive and sealant formulations. Blends fabricated under high shear melt processing conditions, (for example, where the shear rate is greater than 30 sec⁻¹) can be used to produce for example film, foamed or injection molded parts for a range of applications,

All references herein to elements or metals belonging to a certain Group refer to the Periodic Table of the Elements published and copyrighted by CRC Press, Inc., 1989. Also any reference to the Group or Groups shall be to the Group or Groups as reflected in this Periodic Table of the Elements using the IUPAC system for numbering groups.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The term “immiscible” as used herein refers to individual blend components which are immiscible in each other. For example, polymers are considered to be immiscible when, in a blend of the two or more polymers, the individual blend components can still be identified by electron microscopy as discrete domains, or by their characteristic thermal transitions (such as the glass transition, Tg) which can still be discerned.

The term “substantially random” in the substantially random interpolymer comprising polymer units derived from ethylene or ethylene in combination with one or more α-olefin monomers with one or more vinyl aromatic monomers as used herein means that the distribution of the monomers of said interpolymer can be described by the Bernoulli statistical model or by a first or second order Markovian statistical model, as described by J. C. Randall in POLYMER SEQUENCE DETERMINATION Carbon-13 NMR Method, Academic Press New York, 1977, pp. 71-78. Preferably, substantially random interpolymers do not contain more than 15 percent of the total amount of vinyl aromatic monomer in blocks of vinyl aromatic monomer of more than 3 units. This means that in the carbon⁻¹³ NMR spectrum of the substantially random interpolymer the peak areas corresponding to the main chain methylene and methine carbons representing either meso diad sequences or racemic diad sequences should not exceed 75 percent of the total peak area of the main chain methylene and methine carbons.

The substantially random interpolymers used as blend components in the present invention are prepared by polymerizing i) ethylene, or ethylene in combination with one or more C₃ to C₂₀ α-olefin monomers and ii) one or more vinyl aromatic monomers, and optionally iii) other polymerizable ethylenically unsaturated monomer(s).

Suitable α-olefins include for example, α-olefins containing from 3 to 20, preferably from 3 to 12, more preferably from 3 to 8 carbon atoms. Particularly suitable are ethylene, propylene, butene-1, 4-methyl-1-pentene, hexene-1 or octene-1 or ethylene in combination with one or more of propylene, butene-1, 4-methyl-1-pentene, hexene-1 or octene-1. These α-olefins do not contain an aromatic moiety.

Suitable vinyl aromatic monomers, which can be employed to prepare the interpolymers, include, for example, those represented by the following formula:

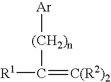

wherein R¹ is selected from the group of radicals consisting of hydrogen and alkyl radicals containing from 1 to 4 carbon atoms, preferably hydrogen or methyl; each R² is independently selected from the group of radicals consisting of hydrogen and alkyl radicals containing from 1 to 4 carbon atoms, preferably hydrogen or methyl; Ar is a phenyl group or a phenyl group substituted with from 1 to 5 substituents selected from the group consisting of halo, C₁₋₄-alkyl, and C₁₋₄-haloalkyl; and n has a value from zero to 4, preferably from zero to 2, most preferably zero. Exemplary vinyl aromatic monomers include styrene, vinyl toluene, α-methylstyrene, t-butyl styrene, chlorostyrene, including all isomers of these compounds. Particularly suitable such monomers include styrene and lower alkyl- or halogen-substituted derivatives thereof. Preferred monomers include styrene, α-methyl styrene, the lower alkyl-(C₁-C₄) or phenyl-ring substituted derivatives of styrene, such as for example, ortho-, meta-, and para-methylstyrene, the ring halogenated styrenes, para-vinyl toluene or mixtures thereof. A more preferred aromatic vinyl monomer is styrene.

Other optional polymerizable ethylenically unsaturated monomer(s) include norbornene and C₁₋₁₀ alkyl or C₆₋₁₀ aryl substituted norbornenes, with an exemplary interpolymer being ethylene/styrene/norbornene.

The most preferred substantially random interpolymers are the ethylene/styrene, ethylene/propylene/styrene, ethylene/styrene/norbornene, and interpolymers.

The substantially random interpolymers include the pseudo-random interpolymers as described in EP-A-0,416,815 B1 and EP-A-0,765,888 by James C. Stevens et al. and U.S. Pat. No. 5,703,187 by Francis J. Timmers. The substantially random interpolymers also include the interpolymers of ethylene, olefinic monomers and vinyl aromatic monomers as described in U.S. Pat. No. 5,872,201 by Yunwa W. Cheung et al. The substantially random interpolymers can be prepared by polymerizing a mixture of polymerizable monomers in the presence of one or more metallocene or constrained geometry catalysts in combination with various cocatalysts. Preferred operating conditions for such polymerization reactions are pressures from atmospheric up to 3000 atmospheres and temperatures from −30° C. to 200° C. as described in U.S. Pat. Nos. 6,048,909 and 6,231,795 B1. Polymerizations and unreacted monomer removal at temperatures above the autopolymerization temperature of the respective monomers may result in formation of some amounts of homopolymer polymerization products resulting from free radical polymerization.

Examples of suitable catalysts, co catalysts, and methods for preparing the substantially random interpolymers are disclosed in U.S. Pat. Nos. 5,055,438; 5,057,475; 5,096,867; 5,064,802; 5,132,380; 5,189,192; 5,321,106; 5,347,024; 5,350,723; 5,374,696; 5,399,635; 5,470,993; 5,703,187; 5,721,185, 5,866,704, 5,959,047, 5,919,983, 6,015,868, 6,118,013 and 6,150,297.

The substantially random α-olefin/vinyl aromatic interpolymers can also be prepared by the methods described in JP 07/278230 employing compounds shown by the general formula

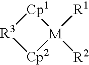

where Cp¹ and Cp² are cyclopentadienyl groups, indenyl groups, fluorenyl groups, or substituents of these, independently of each other; R¹ and R² are hydrogen atoms, halogen atoms, hydrocarbon groups with carbon numbers of 1-12, alkoxyl groups, or aryloxyl groups, independently of each other; M is a group IV metal, preferably Zr or Hf; most preferably Zr; and R³ is an alkylene group or silanediyl group used to cross-link Cp¹ and Cp².

The substantially random α-olefin/vinyl aromatic interpolymers can also be prepared by the methods described by John G. Bradfute et al. (W. R. Grace & Co.) in WO 95/32095; by R. B. Pannell (Exxon Chemical Patents, Inc.) in WO 94/00500; and in Plastics Technology p. 25 (September 1992).

Also suitable are the substantially random interpolymers which comprise at least one α-olefin/vinyl aromatic/vinyl aromatic/α-olefin tetrad disclosed in U.S. Pat. No. 6,191,245 B1 by Francis J. Timmers et al. These interpolymers contain additional signals in their carbon-13 NMR spectra with intensities greater than three times the peak to peak noise. These signals appear in the chemical shift range 43.70-44.25 ppm and 38.0-38.5 ppm. Specifically, major peaks are observed at 44.1, 43.9, and 38.2 ppm. A proton test NMR experiment indicates that the signals in the chemical shift region 43.70-44.25 ppm are methine carbons and the signals in the region 38.0-38.5 ppm are methylene carbons.

Further preparative methods for the interpolymers used in the present invention have been described in the literature. Longo and Grassi (Makromol. Chem. Volume 191, pages 2387 to 2396 [1990]) and D'Anniello et al. (Journal of Applied Polymer Science, Volume 58, pages 1701-1706 [1995]) reported the use of a catalytic system based on methylalumoxane (MAO) and cyclopentadienyltitanium trichloride (CpTiCl₃) to prepare an ethylene-styrene copolymer. Xu and Lin (Polymer Preprints, Am. Chem. Soc., Div. Polym. Chem.) Volume 35, pages 686,687 [1994]) have reported copolymerization using a MgCl₂/TiCl₄/NdCl₃/Al(iBu)₃ catalyst to give random copolymers of styrene and propylene. Sernetz and Mulhaupt, (Macromol. Chem. Phys., v. 197, pp. 1071-1083, 1997) have described the influence of polymerization conditions on the copolymerization of styrene with ethylene using Me₂Si(Me₄Cp)(N-tert-butyl)TiCl₂/methylaluminoxane Ziegler-Natta catalysts. Copolymers of ethylene and styrene produced by bridged metallocene catalysts have been described by Arai, Toshiaki and Suzuki (Polymer Preprints, Am. Chem. Soc., Div. Polym. Chem.) Volume 38, pages 349, 350 [1997]) and in DE 197 11 339 A1 and U.S. Pat. No. 5,883,213 to Denki Kagaku Kogyo K K. The manufacture of α-olefin/vinyl aromatic monomer interpolymers such as propylene/styrene and butene/styrene are described in U.S. Pat. No. 5,244,996, issued to Mitsui Petrochemical Industries Ltd.

While preparing the substantially random interpolymer, an amount of atactic vinyl aromatic homopolymer may be formed due to homopolymerization of the vinyl aromatic monomer at elevated temperatures. The presence of vinyl aromatic homopolymer is in general not detrimental for the purposes of the present invention and can be tolerated. The vinyl aromatic homopolymer may be separated from the interpolymer, if desired, by extraction techniques such as selective precipitation from solution: with a non solvent for either the interpolymer or the vinyl aromatic homopolymer. For the purpose of the present invention it is preferred that no more than 30 weight percent, preferably less than 20 weight percent based on the total weight of the interpolymers of atactic vinyl aromatic homopolymer is present.

When in the blend, or the final solid state form of the blend that is used in an application, such as a fabricated part, one or more of the interpolymer components may be modified by various cross-linking processes. Such cross-linking processes include, but are not limited to, peroxide-, silane-, sulfur-, radiation-, or azide-based cure systems. A full description of the various cross-linking technologies is described in copending U.S. Pat. Nos. 5,869,591 and 5,977,271, the entire contents of both of which are herein incorporated by reference.

Dual cure systems, which use a combination of heat, moisture cure, and radiation steps, may be effectively employed. Dual cure systems are disclosed and claimed in U.S. Pat. Nos. 5,911,940 and 6,124,370, the entire contents of both of which are incorporated herein by reference. For instance, it may be desirable to employ peroxide crosslinking agents in conjunction with silane crosslinking agents, peroxide crosslinking agents in conjunction with radiation, sulfur-containing crosslinking agents in conjunction with silane crosslinking agents, etc.

The polymer compositions may also be modified by various cross-linking processes including, but not limited to the incorporation of a diene component as an additional monomer in the interpolymers and subsequent cross linking by the aforementioned methods and further methods including vulcanization via the vinyl group using sulfur for example as the cross linking agent. The Interpolymer Blend Compositions, their Production and their Utility

The immiscible blend compositions comprise two or more substantially random α-olefin/vinyl aromatic monomer interpolymers, having as one component (A) from 5 to 95, preferably from 15 to 80, more preferably from 30 to 70 weight percent of one or more interpolymer blend components comprising from 2 to 7 mole percent, preferably from 2.5 to 6 mole percent and more preferably from 3 to 5.5 mole percent of one or more vinyl aromatic monomers and from 93 to 98 mole percent, preferably from 94 to 97.5 mole percent and more preferably from 94.5 to 97 mole percent) of one or more C₂ to C₂₀ α-olefin monomers. The preferred α-olefin monomers are ethylene; or a combination of ethylene and at least one of propylene, 4-methyl-1-pentene, butene-1, hexene-1, octene-1 or norbornene. This interpolymer blend component has an overall polyethylene equivalent crystallinity as measured by differential scanning calorimetry of at least 20 wt. %, preferably at least 25 wt %. The specific interpolymer blend components having 2 to 7 mole percent vinyl aromatic monomer have been found to have a desirable balance of mechanical properties such as intrinsic tear properties, compatibility and processability. As such they are identified as preferred interpolymer blend components.

This interpolymer blend component (A) is utilized in combination with:

B) 5 to 95, preferably from 20 to 85, more preferably from 30 to 70 weight percent of one or more substantially random interpolymers having an overall crystallinity (as measured by differential scanning calorimetry) of less than 15, preferrably less than 10 wt. %, comprising:

a) greater than 10 mole percent of one or more vinyl aromatic monomers;

b) the balance comprising ethylene; or a combination of ethylene and at least one or more C₃ to C₂₀ α-olefin monomers;

c) optionally one or more additional olefin monomers; or

C) 5 to 95 preferably from 20 to 85, more preferably from 30 to 70 weight percent of one or more substantially random interpolymers having an overall crystallinity (as measured by differential scanning calorimetry) of greater than 40 wt. %, preferably greater than 45 wt. %, comprising:

a) less than 3 mole percent of one or more vinyl aromatic monomers

b) the balance comprising ethylene; or a combination of ethylene and at least one or more C₃ to C₂₀ α-olefin monomers.

c) optionally one or more additional olefin monomers.

The interpolymer blend components can individually cover a broad range of molecular weights and molecular weight distributions.

The amount of vinyl aromatic comonomer in the interpolymer blend component (A) differs from that in the second interpolymer component (B) by an amount which results in an immiscible blend system. If the interpolymer is an ethylene/styrene interpolymer, an immiscible blend typically results when there is a copolymer styrene difference of at least 10 weight percent. The immiscible nature of blends can be manifested and identified in the blends in that each component retains its characteristic thermal transition behavior such as Tg or crystalline melting transitions, or by the respective blend components being identifiable by microscopic techniques, including atomic force microscopy.

In a preferred embodiment; blends of ethylene styrene interpolymers are characterized by having an overall styrene content in the range 20 to 50 wt. percent styrene, and are designed to provide superior performance/ processability compared to a single interpolymer of the same copolymer styrene content. These blends have significantly enhanced TMA softening points either compared to the performance of a single component interpolymer of similar styrene content, or compared to the weighted average of the TMA softening points of the individual blend components.

In a further embodiment, the blend will contain three or more components that when combined together meet the overall requirements of immiscibility, but with the proviso that the third or additional component may be immiscible or miscible with either component (A) or component (B) or component (C) above.

The blends of the present invention may be prepared known methods including, but not limited to, solution blending, or dry blending the interpolymer blend components in a pelletized form in the desired proportions followed by melt blending in an extruder, Banbury mixer or the like. The dry blended pellets may be directly melt processed into a final solid state article by, for example, injection molding. Alternatively, the blends may be made by direct polymerization, without isolation of the blend components, using for example two or more catalysts in one reactor, or by using a single catalyst and two or more reactors in series or parallel.

The blends of the present invention show performance advantages including, but not limited to, increased heat resistance, tensile strength, tear strength and heat seal capability. The blends further show improved processability such as lower cycle times and improved set up/demolding during injection molding. The blends can be utilized to produce a wide range of fabricated articles such as calendered sheet, blown or cast films, injection-molded articles (for example, toys), rotomolded or thermoformed parts. The blends can be used in wire and cable applications and to produce extrusion profiles such as gaskets. The blends can be used in the manufacture of fibers, foams and latexes, and be utilized in adhesive and sealant formulations. Blends fabricated under high shear melt processing conditions, (for example, where the shear rate is greater than 30 sec⁻¹) to produce for example film, foamed or injection molded parts may have significantly different properties resulting from flow induced morphology compared to low shear processing such as compression molding. For example, fabricated articles and films prepared from an interpolymer blend may have improved optical properties such as low haze or transparency.

Also included as a potential component of the polymer compositions used in the present invention are various organic and inorganic fillers, the identity of which depends upon the type of application for which the composition is to be utilized.

Representative examples of such fillers include organic and inorganic fibers such as those made from asbestos, boron, graphite, ceramic, glass, metals (such as stainless steel) or polymers (such as aramid fibers) talc, carbon black, carbon fibers, calcium carbonate, alumina trihydrate, glass fibers, marble dust, cement dust, clay, feldspar, silica or glass, fumed silica, alumina, magnesium oxide, magnesium hydroxide, antimony oxide, zinc oxide, barium sulfate, aluminum silicate, calcium silicate, titanium dioxide, titanates, aluminum nitride, B₂O₃, nickel powder or chalk.

Other representative organic or inorganic, fiber or mineral, fillers include carbonates such as barium, calcium or magnesium carbonate; fluorides such as calcium or sodium aluminum fluoride; hydroxides such as aluminum hydroxide; metals such as aluminum, bronze, lead or zinc; oxides such as aluminum, antimony, magnesium or zinc oxide, or silicon or titanium dioxide; silicates such as asbestos, mica, clay (kaolin or calcined kaolin), calcium silicate, feldspar, glass (ground or flaked glass or hollow glass spheres or microspheres or beads, whiskers or filaments), nepheline, perlite, pyrophyllite, talc or wollastonite; sulfates such as barium or calcium sulfate; metal sulfides; cellulose, in forms such as wood or shell flour; calcium terephthalate; and liquid crystalsAlso included are the various classes of fillers that act as anti-microbial agents. Mixtures of more than one such filler may be used as well.

Additives such as antioxidants (for example, hindered phenols such as, for example, Irganox™ 1010), phosphites (for example, lrgafos™ 168) both trademarks of, and commercially available from, Ciba Geigy Corporation), U. V. stabilizers, cling additives (for example, polyisobutylene), antiblock additives, colorants, pigments, fillers, tackifiers are optionally also included in the substantially random interpolymers, either in the component interpolymers and/or the overall blend compositions of the present invention, to the extent that they do not interfere with the enhanced properties discovered by Applicants.

The additives are advantageously employed in functionally equivalent amounts known to those skilled in the art. For example, the amount of antioxidant employed is that amount which prevents the polymer or polymer blend from undergoing oxidation at the temperatures and environment employed during storage and ultimate use of the polymers. Such amount of antioxidants is usually in the range of from 0.01 to 10, preferably from 0.05 to 5, more preferably from 0.1 to 2 percent by weight based upon the weight of the polymer or polymer blend. Similarly, the amounts of any of the other enumerated additives are the functionally equivalent amounts such as the amount to render the polymer or polymer blend antiblocking, to produce the desired amount of filler loading to produce the desired result, to provide the desired color from the colorant or pigment. Such additives are advantageously employed in the range of from 0.05 to 50, preferably from 0.1 to 35, more preferably from 0.2 to 20 percent by weight based upon the weight of the polymer or polymer blend.

Processing aids, which are also referred to herein as plasticizers, can also be included in the substantially random interpolymerblend components and/or the overall blend compositions of the present invention., and include the phthalates, such as dioctyl phthalate and diisobutyl phthalate, natural oils such as lanolin, and paraffin, naphthenic and aromatic oils obtained from petroleum refining, and liquid resins from rosin or petroleum feedstocks. Exemplary classes of oils usefull as processing aids include white mineral oil (such as Kaydol™ oil (available from and a registered trademark of Witco), and Shellflex™ 371 naphthenic oil (available from and a registered trademark of Shell Oil Company). Another suitable oil is Tuflo™ oil (available from and a registered trademark of Lyondell).

The following examples are to illustrate this invention and do not limit it.

### EXAMPLES

Blend Component Interpolymers and Blend Compositions

Preparation of Ethylene/Styrene Interpolymers Used in Examples and Comparative Experiments of Present Invention

The interpolymers were prepared in a continuously operating loop reactor. An Ingersoll-Dresser twin screw pump provided the mixing. The reactor ran liquid full at 475 psig (3,275 kPa). Raw materials and catalyst/cocatalyst flows were fed into the reactor through injectors and Kenics static mixers in the loop reactor piping. From the discharge of the loop pump, the process flow goes through two shell and tube heat exchangers before returning to the suction of the loop pump. Upon exiting the last exchanger, loop flow returned through the injectors and static mixers to the suction of the pump. A second monomer/feed injector and mixer was used if available. Heat transfer oil or tempered water was circulated through the exchangers jacket to control the loop temperature. The exit stream of the loop reactor was taken off between the two exchangers. The flow and solution density of the exit stream was measured by a Micro-Motion™ mass flow meter.

Solvent was injected to the reactor primarily as part of the feed flow to keep the ethylene in solution. A split stream from the pressurization pumps prior to ethylene injection was taken to provide a flush flow for the loop reactor pump seals.Additional solvent was added as a diluent for the catalyst Feed solvent was mixed with uninhibited styrene monomer on the suction side of the pressurization pump. The pressurization pump supplied solvent and styrene to the reactor at approximately 650 psig (4,583 kPa). Fresh styrene flow was measured by a Micro-Motion™ mass flow meter, and total solvent/styrene flow was measured by a separate Micro-Motion™ mass flow meter. Ethylene was supplied to the reactor at approximately 690 psig (4,865 kPa). The ethylene stream was measured by a Micro-Motion™ mass flow meter. A flow meter/controller was used to deliver hydrogen into the ethylene stream at the outlet of the ethylene control valve.

The ethylene/hydrogen mixture was at ambient temperature when it was combined with the solvent/styrene stream. The temperature of the entire feed stream as it entered the reactor loop was lowered to approximately 2° C. by a glycol cooled exchanger. Preparation of the three catalyst components took place in three separate tanks. Fresh solvent and concentrated catalyst/cocatalyst/secondary co-catlayst premix were added and mixed into their respective run tanks and fed into the reactor via a variable speed Pulsafeeder™ diaphragm pumps. As previously explained, the three component catalyst system entered the reactor loop through an injector and static mixer into the suction side of the twin screw pump. The raw material feed stream was also fed into the reactor loop through an injector and static mixer upstream of the catalyst injection point or through a feed injector/mixer between the two exchangers, if available.

Polymerization was stopped with the addition of catalyst kill (water) into the reactor product line after the Micro-Motion™ mass flow meter measuring the solution density. A static mixer in the line provided dispersion of the catalyst kill and additives in the reactor effluent stream. This stream next entered post reactor heaters that provided additional energy for the solvent removal flash. This flash occurred as the effluent exited the post reactor heater and the pressure was dropped from 475 psig (3,275 kPa) down to approximately 450 mmHg (60 kPa) of absolute pressure at the reactor pressure control valve.

This flashed polymer entered the devolatilization section of the process. The volatiles flashing from the devolatilization were condensed with a glycol jacketed exchanger, passed through vacuum pump, and were discharged to vapor/liquid separation vessel. In the first stage vacuum system, solvent/styrene were removed from the bottom of this vessel as recycle solvent while unreacted ethylene exhausted from the top. The ethylene stream was measured with a Micro-Motion™ mass flow meter. The measurement of vented ethylene plus a calculation of the dissolved gases in the solvent/styrene stream were used to calculate the ethylene conversion. The polymer and remaining solvent was pumped with a gear pump to a final devolatilizer. The pressure in the second devolatilizer was operated at approximately 10 mmHg (1.4 kPa) absolute pressure to flash the remaining solvent. The dry polymer (<1000 ppm total volatiles) was pumped with a gear pump to an underwater pelletizer with spin-dried, and collected. The preparation conditions for each sample were summarized in Table 1.

Test Methods.

Melt Flow Measurements: Unless otherwise stated, the molecular weight of the polymer compositions for use in the present invention was conveniently indicated using a melt index measurement according to ASTM D-1238, Condition 190° C./2.16 kg (formally known as “Condition (E)” and also known as I₂) was determined.

Thermal Mechanical Analysis (TMA): Upper service temperature was determined from a thermal mechanical analyzer (Perkin-Elmer TMA 7 series) scanned at 5° C./min and a load of 1 Newton and defined as the point at which the probe penetrates 1 mm into the sample. By comparison with an ESI of 30 wt. percent copolymer styrene, which has an upper service temperature of 73° C. as measured by TMA, the value of 87.8° C. recorded for the blend composition was significantly higher. This blend also shows improved shear thinning from melt rheology, higher intrinsic tear, and higher total energy at rupture in tensile stress/strain experiments compared to the ESI of 30 wt. percent copolymer styrene.

Differential Scanning Calorimetry (DSC)

A Dupont DSC-910 was used to measure the thermal transition temperatures and heat of transition for the samples run under nitrogen. In order to eliminate previous thermal history, samples were first heated to about 200° C. Heating and cooling curves were recorded at 10° C./min. Melting (from second heat) and crystallization temperatures were recorded from the peak temperatures of the endotherm and exotherm, respectively.

Dynamic Mechanical Spectroscopey (DMS)

Dynamic mechanical properties of compression molded samples were monitored using a Rheometrics 800E mechanical spectrometer. Samples were run in solid state torsional rectangular geometry and purged under nitrogen to prevent thermal degradation. Generally, the sample was cooled to −100° C. and a strain of 0.05% was applied. Oscillation frequency was fixed at 10 rad/sec and the temperature was ramped in 5° C. increments.

Mechanical Testing

Shore A hardness was measured at room temperature based on ASTM-D240. Intrinsic Tear was determined using Elmendorf Type A method based on ASTM-D1922. Flex modulus was evaluated in the Polyolefins Testing Lab according to ASTM-D790. ASTM-D1708 samples were tested at a strain rate of 5 min⁻¹. Average of four tensile measurements is reported in this study.

Melt Rheology

Dynamic data were taken on a Rheometrics RMS-800 with a nitrogen purge. Frequency/temperature sweeps were performed at 190, 170, and 150° C. with 25 mm parallel plates and a strain within the linear viscoelastic regime. Additionally, the melt strength was determined using the Instron Capillary Rheometer. The samples were extruded at 190° C. with piston speed of 1 in/min. The data were collected on a Goettfert Rheotens.

The blends were produced by dry blending the component interpolymer pellets in defined weight ratios and subsequent melt compounding for 11 minutes in a Haake mixer operating at 180° C. and 30 r.p.m. Test parts were produced from the melt compounded blends by compression molding at 190° C. for 3 minutes at 20,000 psi pressure and subsequent quenching to 25° C.

As a specific example of the invention, an ethylene/styrene interpolymer having 15.9 wt percent copolymer styrene, 0.1 wt percent atactic polystyrene, and a melt flow rate (I₂) of 5.27 and identified as Component A in Table 2 was selected as one of the blend components. A 40/60wt ratio blend of A and Component C having 40 weight percent copolymer styrene and a melt flow rate I₂ of 1.0 was prepared as described above. This blend has an overall copolymer styrene content of 30 wt. percent.

Blends have been designed and produced having 25, 30, 35 and 40 wt percent overall total copolymer styrene.

TABLE 1
Properties of the blend component interpolymers.

| | Wt | wt | | | | | | | |
|---|---|---|---|---|---|---|---|---|---|
| | percent | percent | MI (I₂, | | | | Tg(DSC), | | percent |
| Components | Styrene | APS* | g/10 min) | 10⁻³ Mw | Mw/Mn | Tm, ° C. | ° C. | Tc ° C. | Xtyl |
| A | 15.7 | 0.1 | 1 | 130.9 | 2.2 | 95.7 | −22.3 | 80.1 | 33.8 |
| B | 35 | 0.9 | 0.8 | 187.8 | 2.63 | 48.6 | −22.2 | 23.68 | 9.0 |
| C | 40 | 1.1 | 0.8 | 187.8 | 2.49 | 42.43 | −21.98 | 17.34 | 7.3 |
| D | 60 | 1.2 | 0.5 | 198.7 | 2.4 | | 0.8 | | |
| E | 70 | 4.9 | 1 | 237.4 | 2.44 | | 16.52 | | |
| F | 75 | 8.7 | 1 | 245.1 | 2.25 | | 31.26 | | |
| G | 4.3 | 0.1 | 1.1 | 174.9 | 2.1 | 118.7 | | 104.5 | 52.5 |
| H | 9 | 0 | 1.1 | 170.5 | 2.1 | 110.0 | | 94.5 | 43.9 |
| I | 22 | 0.1 | 1 | 179.1 | 2.0 | 80.3 | −21.2 | 67.7 | 24.4 |
| J | 30 | 0.6 | 1 | 179.3 | 2.96 | 62.42 | −21.53 | 44.48 | 14.6 |

| | | | | | | Intrinsic | | TMA |
|---|---|---|---|---|---|---|---|---|
| | σy, | εb, | σb, | Eb, | Shore | Tear, | Ten Mod, | softening |
| Components | psi | percent | psi | in lb | A | g/mil | psi | point, ° C. |
| A | 777 | 740 | 4603 | 204 | | 429 | 9747 | 101 |
| B | 244 | 630 | 2226 | 80.5 | 72.2 | | 1417 | 64 |
| C | 166 | 777 | 1375 | 58 | 78 | 22.1 | 681 | 53 |
| D | 266 | 537 | 501 | 23.2 | 68 | | 537 | 62 |
| E | 258 | 317 | 3085 | 58.55 | 91.4 | 187 | 14226 | 66 |
| F | 6768 | 4 | 6791 | 2.2 | 99 | 90 | 233323 | 72 |
| G | 2028 | 111 | 4177 | 247 | | 135 | 43595 | 120 |
| H | 1328 | 732 | 4533 | 214 | | 313 | 22350 | 113 |
| I | 542 | 589 | 3949 | 128 | | 351 | 5326 | 83 |
| J | 336 | 653 | 3482 | 113.6 | 80 | 135.5 | 2293 | 73 |

*Atactic Polystyrene

TABLE 2
Summary of Interpolymer blend compositions.

| | wt percent A+ | | T tal wt |
|---|---|---|---|
| | or other | wt percent of 2^{nd} | percent |
| Blend Number | component | c mponent | Styrene* |
| 1 | 50 | 50 percent B | 25 |
| 2 | 60 | 40 percent C | 25 |
| 3 | 78 | 22 percent D | 25 |
| 4 | 25 | 75 percent B | 30 |
| 5 | 40 | 60 percent C | 30 |
| 6 | 66 | 34 percent D | 30 |
| 7 | 72 | 28 percent E | 30 |
| 8 | 75 | 25 percent F | 30 |
| 9 | 20 | 80 percent C | 35 |
| 10 | 56 | 44 percent D | 35 |
| 11 | 64 | 36 percent E | 35 |
| 12 | 67 | 33 percent F | 35 |
| 13 | 44 | 56 percent D | 40 |
| 14 | 55 | 45 percent E | 40 |
| 15 | 59 | 41 percent F | 40 |
| 16 | 40 | 60 percent G | 8 |
| 17 | 50 percent H | 60 percent G | 15 |
| 18 | 50 percent J | H | 21 |

* of blend (based on styrene contents and weight fractions of individual blend components)
+ if not stated

TABLE 3
Interpolymer Blends: Thermal Properties (DSC, DMS, TMA)

| | | T_{c2} | T_{C3} | | percent | TMA | T_{g} | T_{g1} | T_{g2} |
|---|---|---|---|---|---|---|---|---|---|
| | | (Tpeak) | (T onset) | ΔH_{f} | Crystall- | (1 mm) | (DSC) | (DMS) | (DMS) |
| Ex # | Blend #* | C | C | (g/C) | inity | C | C | C | C |
| 1 | 1 | 25.16 | | 64.36 | 22.04 | 92.5 | −21.32 | −10.36 | |
| 2 | 2 | 15.18 | | 65.51 | 22.43 | 96.8 | −21.84 | −10.22 | |
| 3 | 3 | 52 | | 83.21 | 28.50 | 99.8 | | 9.79 | |
| Comp Ex. | ES25 | | | 63.67 | 21.80 | | −20.11 | | |
| 1 | | | | | | | | | |
| 4 | 4 | 25.27 | 63 | 44.68 | 15.30 | 67.1 | −21.79 | −10.05 | |
| 5 | 5 | 14.85 | 62 | 49.56 | 16.97 | 87.8 | −22.02 | −10.14 | |
| 6 | 6 | 50.81 | | 74.44 | 25.49 | 99.3 | | 10.92 | |
| 7 | 7 | 51.77 | | 79.09 | 27.09 | 100 | | 5.01 | 25.66 |
| 8 | 8 | 51.12 | | 78.61 | 26.92 | 100.1 | | 4.43 | 40.22 |
| Comp Ex. | ES30 | | | 42.68 | 14.62 | 72.92 | −21.53 | | |
| 2 | | | | | | | | | |
| 9 | 9 | 14.14 | 63 | 32.98 | 11.29 | 58.8 | −21.49 | −10.12 | |
| 10 | 10 | | | 66.98 | 22.94 | 98.2 | | 10.06 | |
| 11 | 11 | | | 72.92 | 24.97 | 99.2 | | 9.48 | 25.65 |
| 12 | 12 | 52.57 | | 76.2 | 26.10 | 99.1 | | 5.4 | 40.2 |
| Comp Ex. | ES35 | | | 26.2 | 8.97 | | −22.2 | | |
| 3 | | | | | | | | | |
| 13 | 13 | 63.22 | | 57.01 | 19.52 | 92.6 | | 10.39 | |
| 14 | 14 | 51.78 | | 63.19 | 21.64 | 97.9 | | 25.65 | |
| 15 | 15 | | | 66.02 | 22.61 | 98.5 | | 40.19 | |
| Comp Ex. | ES40 | | | 21.4 | 7.33 | 52.9 | −21.98 | | |
| 4 | | | | | | | | | |
| 16 | 16 | 103.36 | | 141.7 | 48.53 | 120.3 | | | |
| Comp Ex. | ES9 | | | | 43.9 | | | | |
| 5 | | | | | | | | | |
| 17 | 17 | 68.59 | | 103.9 | 35.58 | 109.4 | −22.69 | | |
| Comp Ex. | ES15 | | | | 34.5 | | −23.1 | | |
| 6 | | | | | | | | | |
| 18 | 18 | 95.28 | 43 | 78.14 | 26.76 | 106 | −21.81 | −10.15 | |
| Comp Ex. | ES22 | | | | 24.4 | | −21.2 | | |
| 7 | | | | | | | | | |

ES25 is an ethylene styrene interpolymer having a melt index (I₂) of 1.0 g/10 min, a styrene content of 25 weight percent and an ethylene content of 75 weight percent.
ES30 is an ethylene styrene interpolymer having a melt index (I₂) of 1.0 g/10 min, a styrene content of 30 weight percent and an ethylene content of 70 weight percent.
ES35 is an ethylene styrene interpolymer having a melt index (I₂) of 1.0 g/10 min, a styrene content of 35 weight percent and an ethylene content of 65 weight percent.
ES40 is an ethylene styrene interpolymer having a melt index (I₂) of 1.0 g/10 min, a styrene content of 40 weight percent and an ethylene content of 60 weight percent.
ES9 is an ethylene styrene interpolymer having a melt index (I₂) of 1.0 g/10 min, a styrene content of 9 weight percent and an ethylene content of 91 weight percent.
ES15 is an ethylene styrene interpolymer having a melt index (I₂) of 1.0 g/10 min, a styrene content of 15 weight percent and an ethylene content of 85 weight percent.
ES22 is an ethylene styrene interpolymer having a melt index (I₂) of 1.0 g/10 min, a styrene content of 22 weight percent and an ethylene content of 78 weight percent.

TABLE 4
Interpolymer Blends: Mechanical Properties (Tensile, Modulus, Intrinsic Tear)

| | | | | | | | | Intrinsic |
|---|---|---|---|---|---|---|---|---|
| | | | σ_{b} | ε_{b} | σᵥ | ε_{y} | E | Tear |
| Ex # | Blend # | C mposition | (psi) | (percent) | (psi) | (percent) | (psi) | (g/mils) |
| 1 | 1 | 50 ES16/ | 3011.75 | 547.5 | 784.5 | 90.25 | 3624.25 | 227.6232 |
| | | 50 ES35 | | | | | | |
| 2 | 2 | 60 ES16/ | 3031.75 | 588.5 | 781.75 | 97.825 | 3647.25 | 247.7246 |
| | | 40 ES40 | | | | | | |
| 3 | 3 | 78 ES16/ | 3115 | 589 | 852 | 77.24 | 4576.4 | 246.5286 |
| | | 22 ES60 | | | | | | |
| Comp | | ES 25 | 3637 | 606 | 477 | | 3808 | 262.7 |
| Ex. 1 | | | | | | | | |
| 4 | 4 | 25 ES16/ | 2722.8 | 574.4 | 534.2 | 76.12 | 1745.6 | 98.31201 |
| | | 75 ES35 | | | | | | |
| 5 | 5 | 40 ES16/ | 3178 | 639.6 | 599.4 | 82.28 | 2591.8 | 189.1351 |
| | | 60 ES40 | | | | | | |
| 6 | 6 | 66 ES16/ | 2955.6 | 611 | 803 | 83.92 | 4318.4 | 176.1099 |
| | | 34 ES60 | | | | | | |
| 7 | 7 | 72 ES16/ | 4523.8 | 553.2 | 1031.4 | 85.56 | 6258 | 252.1633 |
| | | 28 ES70 | | | | | | |
| 8 | 8 | 75 ES16/ | 4801.2 | 554 | 1768.6 | 137.34 | 8371.4 | 245.6507 |
| | | 25 ES75 | | | | | | |
| Comp | | ES30 | 2377 | 660 | 309 | | 1850 | 135.5 |
| Ex. 2 | | | | | | | | |
| 9 | 9 | 20 ES16/ | 2236.6 | 595.4 | 439.6 | 95.54 | 1142.8 | 56.4785 |
| | | 80 ES40 | | | | | | |
| 10 | 10 | 56 ES16/ | 2331 | 526 | 748.2 | 97.02 | 3142.6 | 246.8937 |
| | | 44 ES60 | | | | | | |
| 11 | 11 | 64 ES16/ | 3984 | 471 | 1045 | 84 | 7350.75 | 175.6301 |
| | | 36 ES70 | | | | | | |
| 12 | 12 | 67 ES16/ | 3678.6 | 419.4 | 1941.8 | 107.56 | 16671.6 | 252.9756 |
| | | 33 ES75 | | | | | | |
| Comp | | ES35 | 2226 | 630 | 244 | | 1417 | 82.4 |
| Ex. 3 | | | | | | | | |
| 13 | 13 | 44 ES16/ | 2194 | 548 | 608.8 | 67.26 | 2541.8 | 172.144 |
| | | 56 ES60 | | | | | | |
| 14 | 14 | 55 ES16/ | 3655.2 | 390.8 | 709.2 | 27.52 | 7473 | 210.6434 |
| | | 45 ES70 | | | | | | |
| 15 | 15 | 59 ES16/ | 2949.4 | 292.4 | 1965.6 | 60.6 | 22274.8 | 142.3581 |
| | | 41 ES75 | | | | | | |
| Comp | | ES40 | 1375 | 777 | 166 | | 681 | 22.1 |
| Ex. 4 | | | | | | | | |
| 16 | 16 | 40 ES16/ | 4452.8 | 664.2 | 1719.4 | 59.42 | 24529 | 333.5209 |
| | | 60 ES4.3 | | | | | | |
| Comp | | ES 9 | 4533 | 732 | 1328 | | 22350 | 313 |
| Ex. 5 | | | | | | | | |
| 17 | 17 | 50 ES8.6/ | 4472.8 | 621.8 | 1225.8 | 75.58 | 12304 | 355.9071 |
| | | 50 ES21.6 | | | | | | |
| Comp | | ES 15 | 4619 | 659 | 780 | | 10069 | 523 |
| Ex. 6 | | | | | | | | |
| 18 | 18 | 60 ES30/ | 3825 | 576.5 | 821.75 | 41.6 | 6783.25 | 328.9203 |
| | | 40 ES8.6 | | | | | | |
| Comp | | ES 22 | 3949 | 589 | 542 | | 5326 | 351 |
| Ex. 7 | | | | | | | | |

1. An immiscible blend of two or more substantially random interpolymers comprising 5 to 95 weight percent of at least one substantially random interpolymer having an overall crystallinity (as measured by differential scanning calorimetry) of at least 20 wt percent, said interpolymer comprising:
a) from 2 to 7 mole percent of one or more vinyl aromatic monomers and
b) the balance comprising ethylene; or a combination of ethylene and at least one or more C₃ to C₂₀ α-olefin monomers, and
c) optionally other olefin monomers

2. An immiscible blend of claim 1 comprising two or more substantially random interpolymers, said interpolymers comprising;
A) from 10 to 90 weight percent of one or more substantially random interpolymers having an overall crystallinity (as measured by differential scanning calorimetry) of at least 25 wt percent ; comprising
a) from 2 to 7 mole percent of one or more vinyl aromatic monomers and
b) the balance comprising ethylene; or a combination of ethylene and at least one or more C₃ to C₂₀ α-olefin monomers, and
c) optionally other olefin monomers,
B) from 10 to 90 weight percent of one or more substantially random interpolymers having an overall crystallinity (as measured by differential scanning calorimetry) of less than 15 wt. percent; comprising
a) greater than 10 mole percent of one or more vinyl aromatic monomers and
b) the balance comprising ethylene; or a combination of ethylene and at least one or more C₃ to C₂₀ α-olefin monomers, and
c) optionally other olefin monomers:

3. An immiscible blend of claim 1 comprising two or more substantially random interpolymers, said interpolymers comprising;
A) from 10 to 90 weight percent of one or more substantially random interpolymers having an overall crystallinity (as measured by differential scanning calorimetry) of at least 25 wt percent; comprising
a) from 2 to 7 mole percent of one or more vinyl aromatic monomers and
b) the balance comprising ethylene; or a combination of ethylene and at least one or more C₃ to C₂₀ α-olefin monomers, and
c) optionally other olefin monomers,
in combination with
B) from 10 to 90 weight percent of one or more substantially random interpolymers having an overall crystallinity (as measured by differential scanning calorimetry) of greater than 40 wt. percent, comprising:
a) less than 3 mole percent of one or more vinyl aromatic monomers; and
b) the balance comprising ethylene; or a combination of ethylene and at least one or more C₃ to C₂₀ α-olefin monomers; and
c) optionally one or more additional olefin monomers.

4. The immiscible blend of claim 2 comprising;:
A) from 15 to 80 weight percent of one or more substantially random interpolymers comprising
a) from 2.5 to 6 mole percent of one or more vinyl aromatic monomers and
b) the balance comprising ethylene; or a combination of ethylene and at least one or more C₃ to C₁₂ α-olefin monomers; and
B) from 20 to 85 weight percent of one or more substantially random interpolymers comprising
a) from 10 to 65 mole percent of one or more vinyl aromatic monomers and
b) the balance comprising ethylene; or a combination of ethylene and at least one or more C₃ to C₁₂ α-olefin monomers.

5. The immiscible blend of claim 2 comprising;:
A) from 30 to 70 weight percent of one or more substantially random interpolymers comprising
a) from 3 to 5.5 mole percent of one or more vinyl aromatic monomers and
b) the balance comprising ethylene; or a combination of ethylene and at least one or more C₃ to C₁₂ α-olefin monomers; and
B) from 30 to 70 weight percent of one or more substantially random interpolymers comprising
a) from 12 to 50 mole percent of one or more vinyl aromatic monomers; and
b) the balance comprising ethylene; or a combination of ethylene and at least one or more C₃ to C₁₂ α-olefin monomers.

6. The blend of claims 1-3 wherein said substantially random interpolymer of Component A and B is an interpolymer of ethylene and a vinyl aromatic monomer selected from the group consisting of styrene and alkyl substituted styrenes.

7. The blend of claims 1-3 wherein substantially random interpolymer of said Components A and B is an interpolymer of ethylene, propylene and a vinyl aromatic monomer selected from the group consisting of styrene and alkyl substituted styrenes.

8. The blend of claim 2 wherein the softening point of the final blend is greater than either that of a single component interpolymer of similar styrene content, or the weighted average of the softening points of the individual blend components.

9. The blend of claim 2 wherein the additive overall vinyl aromatic monomer content of the final blend is less than 19 mol percent.

10. A blend of any of claims 1-9 wherein the interpolymer components are produced by copolymerization of two or more appropriate monomers in the presence of a metallocene catalyst and a co-catalyst.

11. An adhesive or sealant system comprising an interpolymer blend of any one of claims 1-9.

12. Sheet or film resulting from calendering, blowing or casting an interpolymer blend of any one of claims 1-9.

13. Injection, compression, extruded, blow molded, rotomolded or thermoformed parts prepared from an interpolymer blend of any one of claims 1-9.

14. Fibers, foams or latices prepared from an interpolymer blend of any one of claims 1-9.

15. Fabricated articles or foamed structures prepared from an interpolymer blend of any one of claims 1-9.

16. Fabricated articles, films and foams produced by a high critical shear rate melt processing operation prepared from an interpolymer blend of any one of claims 1-9, wherein said high critical shear rate is greater than 30 sec⁻¹.

17. The fabricated articles or films of claim 16, wherein the softening point of the article or film is greater than either that of an article or film produced from a single component interpolymer of similar styrene content, or the weighted average of the softening points of the article or film produced from the individual blend components.
